(19) United States
(12) Patent Application Publication
(10) Pub. No.: US 2009/0321166 A1
(43) Pub. Date: Dec. 31, 2009

(54) METHOD FOR OPERATING A HYBRID DRIVE FOR A VEHICLE

(76) Inventors: Jens-Werner Falkenstein, Aalen (DE); Michael Glora, Markgroeningen (DE); Michael Mecks, Hiddenhausen (DE)

Correspondence Address: KENYON & KENYON LLP, ONE BROADWAY, NEW YORK, NY, 10004, US

(21) Appl. No.: 12/282,665

(22) PCT Filed: Mar. 9, 2007
(86) PCT No.: PCT/EP07/52229

§ 371 Date: Mar. 5, 2009

(30) Foreign Application Priority Data
Mar. 21, 2006 (DE) 10 2006 012 860.5

(51) Int. Cl. B60W 20/00; H02P 7/18

(52) U.S. Cl. 180/65.285; 318/452

(57) ABSTRACT

A method for operating a hybrid drive for a vehicle including at least one internal combustion engine and at least one electric motor, the internal combustion engine and the electric motor being operable in a hybrid mode, which enables a temporary power boost by supplementing the internal combustion engine output with electric motor output. The temporary power boost is allowed only until reaching a limit velocity (V_{G}), which depends on the maximum velocity (V_{SM}, V_{SM′}) in internal combustion engine mode, which depends on the particular driving resistance.

### FIELD OF THE INVENTION

The present invention relates to a method for operating a hybrid drive for a vehicle having at least one internal combustion engine and at least one electric motor, the internal combustion engine and the electric motor being operable in a hybrid mode, which allows a temporary power boost by supplementing internal combustion engine power with electric motor power.

### BACKGROUND INFORMATION

Such a method for operating a hybrid drive for a vehicle is known. A temporary power boost by supplementing internal combustion engine power with electric motor power (boost operation) is used in particular in hybrid drive concepts in which the dimensions of the internal combustion engine are smaller than those of a conventional drive and the internal combustion engine power is accordingly lower (downsizing concept). The internal combustion engine power is used to carry a basic load while the additional electric motor power is used mainly to improve the dynamics of the hybrid drive in acceleration operations, for example. The electric motor compensates well for power weaknesses occurring with the internal combustion engine in particular because the internal combustion engine supplies a high torque in the upper rotational speed range and the electric motor supplies a high torque in the low rotational speed range. However, the energy capacity of an electrical storage device provided for the electric motor is limited, so there may be only a temporary power boost beyond the internal combustion engine power. Such phases of power boost by the electric motor must be followed accordingly by long phases during which the electrical storage device is recharged. During these phases, the hybrid drive has access only to the internal combustion engine power minus a charging power for charging an electrical storage device supplying power to the electric motor. To keep the electrical storage device in a suitable charge state, the temporary power boost must be limited.

### SUMMARY OF THE INVENTION

The method according to the present invention for operating a hybrid drive for a motor vehicle is characterized in that the temporary power boost is allowed only until reaching a limit velocity, which depends on a maximum velocity, which depends on the particular driving resistance in internal combustion engine mode. Limitation of the temporary power boost as a function of a maximum velocity reachable only in operation with the internal combustion takes into account the fact that after a phase of temporary power boost, the internal combustion engine alone must drive the vehicle. In internal combustion engine mode, however, the maximum velocity depends on the particular prevailing driving resistance and may vary greatly. The particular driving resistance is composed in particular of a rolling resistance, an air resistance and a slope resistance of the vehicle.

According to a refinement of the present invention, the driving resistance is calculated from variables which vary on the basis of the particular driving state, in particular the output torque of the hybrid drive, the vehicle acceleration and mass moments of inertia of rotating vehicle parts as well as the vehicle mass. To determine the maximum velocity in internal combustion engine mode depending on the prevailing driving resistance, first the driving resistance must be determined.

This is obtained from a tractive force of the hybrid drive, which depends on the output torque of the hybrid drive, minus an acceleration force which is required for acceleration of the vehicle. This acceleration force is the product of the vehicle acceleration and the vehicle mass, whereby the mass moments of inertia of rotating vehicle parts are counted as the mass.

It is expedient that the maximum velocity in internal combustion engine mode depends on a particular charge state of at least one electrical storage device assigned to the electric motor and a resulting power demand of a generator charging the electrical storage device, as well as a power demand of the vehicle electrical system. In internal combustion engine mode following a time phase of temporary power boost, the internal combustion engine must cover the power demand of the generator charging the electrical storage device plus the power demand of the vehicle electrical system to ensure a hybrid mode with a temporary power boost in the long run. The drive thus has access only to the power of the internal combustion engine minus the electrical power demand.

Furthermore, it is advantageous if the temporary power boost is utilized exclusively for acceleration processes. Such acceleration operations, which are limited in time in particular, result from typical driving situations in highway traffic such as starting the vehicle or a passing maneuver on a highway, e.g., a freeway. However, a temporary power boost by electric motor power to overcome driving resistance is not advisable in many cases because such driving situations last for a much longer period of time than allowed by the charge state of the electrical storage device.

It may be provided that the limit velocity corresponds to the particular maximum velocity in internal combustion engine mode. In the simplest case, a temporary power boost by electric motor power is no longer allowed after reaching the particular maximum velocity in internal combustion engine mode.

According to a refinement of the exemplary embodiments and/or exemplary methods of the present invention, the temporary power boost is used for a temporary increase in vehicle velocity above the maximum velocity in internal combustion engine mode. Such an increase in vehicle velocity may be allowed for a limited amount of time if, for example, the electrical storage device is completely charged or almost completely charged.

Furthermore, it is advantageous if the particular maximum velocity in internal combustion engine mode is ascertained as a function of the possible gear ratios of a drive transmission. The maximum velocity in internal combustion engine mode is not to be ascertained based on a certain gear ratio—for example, the particular selected gear ratio—but instead is ascertained as the maximum over all possible gear ratios.

It is provided in particular that the kinetic energy of the vehicle during braking is used to charge the electrical storage device by the generator. In driving states characterized by alternating phases of acceleration and subsequent deceleration—e.g., in city traffic—the generator may be driven in the braking phases by the kinetic energy of the vehicle. Such a recovery of energy (recuperation) ensures more rapid recharging of the electrical storage device for lower fuel consumption.

According to a further embodiment of the present invention, the temporary power boost is possible only up to a predefined maximum period of time. In addition to other restrictions, the temporary power boost may also be limited to a maximum period of time, which is followed, for example, by a minimal period of time, which is also predefined, having exclusively an internal combustion engine drive and recharging of the electrical storage device.

It may be provided that the temporary power boost occurs only when the charge state of the electrical storage device is above a predefined charge threshold. The charge threshold may be, for example, a limit value below which there may not be a temporary power boost for a sufficiently long period of time and/or not enough electrical power is available to start the internal combustion engine.

Furthermore, it is advantageous if the electrical storage device is a rechargeable battery. Such a battery is safe and simple to handle and allows direct storage of electrical power.

Finally, it is provided that the electric motor forms the generator. If the electric motor is also able to operate in generator mode, this eliminates the need for a separate generator and, if necessary, an additional transmission connecting the wheels and generator.

The exemplary embodiments and/or exemplary methods of the present invention is explained in greater detail below in an exemplary embodiment on the basis of the particular drawings.

### BRIEF DESCRIPTION OF THE DRAWINGS

FIGURE shows a diagram plotting a restriction factor as a function of a driving resistance of the vehicle.

FIG. 2 shows a diagram plotting the driving resistance, maximum tractive force in internal combustion engine mode and maximum tractive force in power-boosted mode as a function of a vehicle velocity.

FIG. 3 shows a diagram plotting the driving resistance, driving resistance at an increased slope resistance, maximum tractive force in internal combustion engine mode and maximum tractive force in power-boosted mode as a function of vehicle velocity.

### DETAILED DESCRIPTION

A hybrid drive (not shown) of a vehicle includes, for example, an internal combustion engine, an electric motor, a drive transmission and at least one electrical storage device assigned to the electric motor, a drive train of the internal combustion engine and a drive train of the electric motor being able to be coupled to a transmission input train of the drive transmission via a controllable clutch, enabling the internal combustion engine and/or electric motor to drive the vehicle (parallel hybrid drive).

In the method according to the present invention for operating the hybrid drive, particular driving resistances F_{W} of the vehicle, including rolling resistance, slope resistance and air resistance, are ascertained indirectly. To do so, the variables of an output torque of the hybrid drive, a vehicle acceleration and relevant mass moments of inertia of rotating vehicle parts as well as the vehicle mass, said variables changing as a function of a particular driving state, are ascertained continuously or at intervals in time. Particular driving resistance F_{W} is obtained from a particular tractive force F_{Z}, which depends on the output torque of the hybrid drive, vehicle acceleration a and reduced vehicle mass m, taking into account the vehicle mass as well as the mass moment of inertia of rotating vehicle parts. The relationship between tractive force F_{Z} and driving resistance F_{W} is obtained from the equation

F_{Z}=m·a+F_{W}.

In a parallel hybrid drive, in which the output train of the internal combustion engine is coupled to the output train of an electric motor operating as a generator, for example, the following equation applies for tractive force F_{Z}:

$${F}_{z} = \frac{( {M}_{VM} + {M}_{EM} ) {i}_{g} {η}_{g}}{{r}_{d}} ,$$

where M_{VM} is an actual torque of the internal combustion engine, M_{EM} is an actual torque of the electric motor operating as a generator, i_{g} is an actual total gear ratio of the drive transmission and differential, η_{g} is a total efficiency of the drive train and r_{d} is a dynamic tire radius. The electric motor operating as a generator has the function in generator mode of ensuring the power demand of the vehicle electrical system and/or the electrical storage device. For quasi-steady-state operation, only the internal combustion engine power minus the power demand of the vehicle electrical system is available to the drive. Depending on the charge state (SOC) of the electrical storage device, additional power is required to achieve a setpoint charge state. To control/regulate the temporary power boost (boost) as a function of a maximum velocity vₛₘ, v_{sm′} which depends on the particular driving resistance in internal combustion engine mode, a maximum tractive force F_{Zsm} which is possible under quasi-steady-state conditions and may be achieved in pure internal combustion engine mode is ascertained, with the electrical power demand being met at the same time.

If the vehicle control/regulation has an influence on the drive transmission and its gear ratios, maximum tractive force F_{Zsm} possible under quasi-steady-state conditions may be ascertained as a maximum over all possible gear ratios. In the case of a manual shift transmission, the gear ratio selected by the driver may optionally also be used as the basis for ascertaining maximum tractive force F_{Zsm} possible under quasi-steady-state conditions. Maximum tractive F_{Zsm} is thus obtained as follows:

$${F}_{Zsm} = \frac{( {M}_{VMm} + {M}_{EMsm} ) {i}_{g} {η}_{g}}{{r}_{d}} ,$$

from a maximum torque M_{VMm} of the internal combustion engine at a particular rotational speed n and at a torque M_{EMsm} of the electric motor at a particular rotational speed n at which the electrical power demand is met. Rotational speed n depends on particular vehicle velocity v and the basic gear ratio. M_{EMsm} is usually negative, when the electric motor designed as a generator is operating in generator mode.

However, the torque of the electric motor may also be positive if a high charge state of the electrical storage device is to be dissipated, for example, by supplementing the internal combustion engine power with electric motor power. If a particular driving resistance F_{W} is lower than maximum tractive force F_{Zsm} of the hybrid drive, which is possible under quasi-steady-state conditions, vehicle velocity v may be increased, whereby the electrical power demand is also met. The upper limit velocity forms the maximum velocity possible under quasi-steady-state conditions in internal combustion engine mode vₛₘ at which driving resistance F_{W} corresponds to the quasi-steady-state maximum tractive force in internal combustion engine mode F_{Zsm}.

There may be a possible restriction on the temporary power boost if driving resistance F_{W} approaches the maximum tractive force possible under quasi-steady-state conditions in internal combustion engine operation F_{Zsm}. In this mode of operation, the temporary power boost is used exclusively for acceleration operations of the vehicle. The restriction may be determined by a factor a obtained from driving resistance F_{W}, maximum possible tractive force F_{Zsm} under quasi-steady-state conditions in internal combustion engine mode and a force offset Δ (offset Δ). FIG. 1 shows a diagram 1 in which restriction factor α is plotted as a function of driving resistance F_{W}. If maximum tractive force F_{Zsm} in internal combustion engine mode is greater than driving resistance F_{W} by more than force offset A and this is thus below a tractive force limit F_{Zls}, the temporary power boost is not limited and the following applies:

α=1, when F_{W}<F_{Zsm}−Δ=F_{Zls}.

If driving resistance F_{W} reaches tractive force limit F_{Zls}, which is obtained from maximum tractive force F_{Zsm} in internal combustion engine mode minus force offset Δ, the temporary power boost is always further limited linearly with the difference of F_{Zsm}−F_{W} based on force offset Δ and the following applies:

$$α = \frac{{F}_{Zsm} - {F}_{W}}{Δ} , \\ when$$

$${F}_{Zsm} - Δ < {F}_{W} < {F}_{Zsm} .$$

After reaching maximum tractive force F_{Zsm} in internal combustion engine mode, the temporary power boost according to

α=0 is no longer allowed when F_{W}>F_{Zsm}.

The tractive force available due to the temporary power boost is limited at the upper end by a tractive force maximum F_{Zl} where

F_{Zl}=α·F_{Zbm}+(1−α)·F_{Zsm}.

Maximum possible tractive force F_{Zbm} due to the temporary power boost (boost) is obtained from

$${F}_{Zbm} = \frac{( {M}_{VMm} + {M}_{EMbm} ) {i}_{g} {η}_{g}}{{r}_{d}} ,$$

using a maximum torque M_{EMbm}, usually positive, of the electric motor.

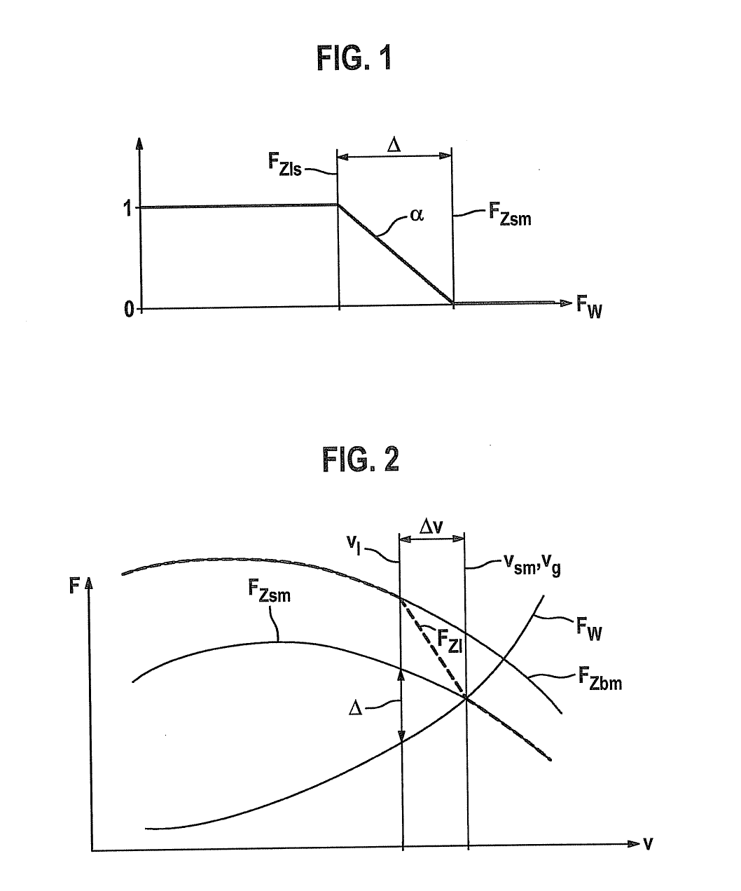

FIG. 2 shows in a diagram the dependence of driving resistance F_{W}, maximum possible tractive force F_{Zbm} with the temporary power boost, maximum possible tractive force F_{Zsm} in internal combustion engine mode and maximum allowed tractive force F_{Zl} (dashed line) as a function of driving velocity v (tractive force diagram). Although the driving resistance has a characteristic line F_{W} which increases steadily with vehicle velocity, the characteristic lines of tractive forces F_{Zsm} and F_{Zbm} have a monotonically declining slope at higher vehicle velocities.

The maximum velocity in internal combustion engine mode vₛₘ occurs at the point of intersection of the characteristic lines of driving resistance F_{W} and maximum possible tractive force F_{Zsm} in internal combustion engine mode. In a velocity range Δv, maximum allowed tractive force F_{Zl} is limited beyond a limit velocity vₗ at which driving resistance F_{W} is lower than tractive force F_{Zsm} only by force offset Δ, maximum allowed tractive force F_{Zl} according to the dashed line being reduced to the curve of the characteristic line of tractive force F_{Zsm} beyond limit velocity vₗ from the curve of the characteristic line of tractive force F_{Zbm} until reaching maximum velocity vₛₘ. For vehicle velocities v above this maximum velocity vₛₘ which is effectively limit velocity v_{g}, a temporary power boost through electric motor power is not allowed. The characteristic line of maximum allowed tractive force F_{Zl} is limited to the curve of the characteristic line of tractive force F_{Zsm} for vehicle velocities v above limit velocity v_{g}.

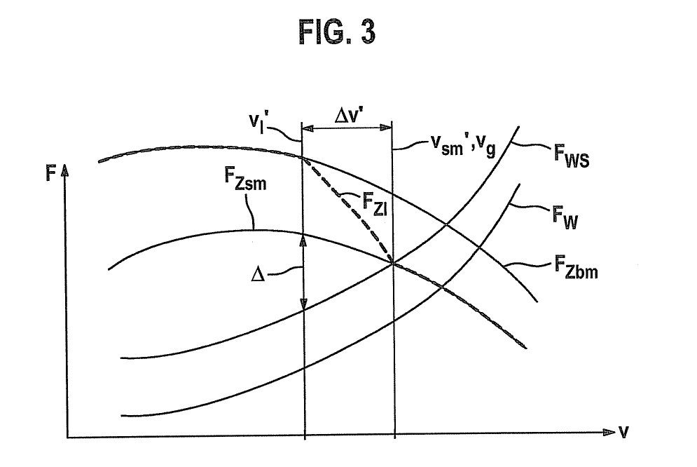

FIG. 3 shows a diagram corresponding essentially to the diagram of FIG. 2 and showing, in addition to driving resistance F_{W}, a driving resistance F_{WS} which is increased by a higher slope resistance. If the driving resistance is increased—e.g., because the vehicle experiences an additional slope resistance on a slope—the maximum velocity in internal combustion engine mode vₛₘ which depends on the particular driving resistance is reduced from position Vₛₘ shown in the diagram in FIG. 2 to position v_{sm′} shown in the diagram in FIG. 3. With a correspondingly lower limit velocity v_{l′}, driving resistance F_{WS} is lower than tractive force F_{Zsm} by only an identical force offset Δ.

1-12. (canceled)

13. A method for operating a hybrid drive for a vehicle having at least one internal combustion engine and at least one electric motor, the method comprising:
operating the internal combustion engine and the electric motor in a hybrid mode which allows a temporary power boost by supplementing internal combustion engine power with electric motor power; and
allowing the temporary power boost only until reaching a limit velocity, which depends on a maximum velocity in an internal combustion engine mode as a function of a particular driving resistance.

14. The method of claim 13, wherein a driving resistance is determined based on variables which change based on a particular driving state corresponding to output torques of the hybrid drive, vehicle acceleration, mass moments of inertia of rotating vehicle parts, and a vehicle mass.

15. The method of claim 13, wherein the maximum velocity in the internal combustion engine mode is a function of a particular charge state of at least one electrical storage device assigned to the electric motor and a resulting power demand of a generator charging the electrical storage device and a power demand of a vehicle electrical system.

16. The method of claim 13, wherein the temporary power boost is used exclusively for acceleration operations.

17. The method of claim 13, wherein the limit velocity corresponds to the particular maximum velocity in the internal combustion engine mode.

18. The method of claim 13, wherein the temporary power boost is used to temporarily increase the vehicle velocity above the maximum velocity in the internal combustion engine mode.

19. The method of claim 13, wherein the particular maximum velocity in the internal combustion engine mode is ascertained as a function of possible gear ratios of a drive transmission.

20. The method of claim 13, wherein the kinetic energy of the vehicle during braking is used to charge the electrical storage device by the generator.

21. The method of claim 13, wherein the temporary power boost is possible only up to a predefinable maximum period of time.

22. The method of claim 13, wherein the temporary power boost occurs only at a charge state of the electrical storage device above a predefined charge threshold.

23. The method of claim 13, wherein the electrical storage device includes a rechargeable battery.

24. The method of claim 13, wherein the electric motor includes a generator.
